(19) United States
(12) Patent Application Publication
(10) Pub. No.: US 2009/0185524 A1
(43) Pub. Date: Jul. 23, 2009

(54) MANUAL CELL DETECTION AND SELECTION PROCEDURES

(75) Inventors: Mohammed Sammour, Montreal (CA); Shankar Somasundaram, Deer Park, NY (US); Jin Wang, Central Islip, NY (US); Rajat P. Mukherjee, Stanford, CA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/344,908

(22) Filed: Dec. 29, 2008

Related U.S. Application Data
(60) Provisional application No. 61/018,587, filed on Jan. 2, 2008.

(51) Int. Cl. H04W 4/00

(52) U.S. Cl. 370/328; 455/434

(57) ABSTRACT

A method for performing a manual cell search by a wireless transmit/receive unit (WTRU) includes receiving a manual cell search command and searching for home enhanced Node B (HeNB) cells during a time period. The time period may be a measurement gap or a discontinuous reception period. If an existing measurement gap is available for the WTRU to use, the search can be performed during that gap. Otherwise, the WTRU can request a new measurement gap to search for HeNBs.

### CROSS REFERENCE TO RELATED APPLICATIONS

This application claims the benefit of U.S. Provisional Application No. 61/018,587, filed Jan. 2, 2008, which is incorporated by reference as if fully set forth herein.

### FIELD OF INVENTION

This application is related to wireless communications.

### BACKGROUND

Current efforts for the 3GPP Long Term Evolution (LTE) program is to bring new technology, new architecture, and new methods in the LTE settings and configurations to provide improved spectral efficiency, reduced latency, and better utilization of the radio resources to provide faster user experiences and richer applications and services with less cost.

As part of these efforts, the 3GPP has introduced the concept of a home enhanced Node B (HeNB) in LTE and in Release 8 WCDMA, GERAN, and other cellular standards. The HeNB is similar to a wireless local area network (WLAN) access point (AP) and is designed to allow access to cellular services over extremely small service areas (e.g., homes or small offices). This can be particularly useful where cellular networks have not been deployed, where legacy radio access technology (RAT) coverage exists, and where cellular coverage may be faint or non-existent for radio related reasons (e.g., in an underground metro or in a shopping mall). The subscriber (e.g., an individual or an organization) can deploy an HeNB over an area where such service is desired.

There is currently no mechanism to allow for manual cell selection or manual HeNB selection. There are mechanisms, however, for manual public land mobile network (PLMN) selection, which leads to cell selection. The current cell selection and re-selection procedures do not allow for manual inputs. Further, WTRU actions on receiving a manual input from the user are undefined.

### SUMMARY

Manual cell detection and selection procedures in a wireless transmit/receive unit (WTRU) are disclosed. Specifically, non-access stratum (NAS) and radio resource control (RRC) procedures on receiving a manual command to search for or to select cells are proposed.

WTRU procedures upon triggering manual cell search and selection are disclosed. Idle mode cell selection and re-selection procedures for manual selection of HeNBs are also disclosed.

### BRIEF DESCRIPTION OF THE DRAWINGS

A more detailed understanding may be had from the following description, given by way of example in conjunction with the accompanying drawings, wherein:

FIG. 1 is a flow chart showing NAS procedures on receipt of a manual command;

FIG. 2 is a flow chart of a method for determining whether an HeNB cell is a suitable cell;

FIG. 3 is a flow chart of a method for determining whether an HeNB cell is an acceptable cell for making emergency calls; and

FIG. 4 is a block diagram of a WTRU configured to perform manual cell detection and selection.

### DETAILED DESCRIPTION

When referred to hereafter, the term “wireless transmit/receive unit (WTRU)” includes, but is not limited to, a user equipment (UE), a mobile station, a fixed or mobile subscriber unit, a pager, a cellular telephone, a personal digital assistant (PDA), a computer, or any other type of user device capable of operating in a wireless environment. When referred to hereafter, the term “base station” includes, but is not limited to, a Node B, a site controller, an access point (AP), or any other type of interfacing device capable of operating in a wireless environment.

Although the discussion below centers on the manual selection of HeNB cells, in principle these ideas may be applied to the manual selection of any cells. The ideas described below are equally applicable to any wireless standard, including, but not limited to, WCDMA, GERAN, 3GPP2, and WiMAX. The procedures described below may be used in any combination for initial configuration of the HeNBs that may be accessed by the WTRU.

When a manual search occurs (i.e., when the user requests a particular cell), all layers of the communication stack take one or more actions in response to the manual request. As will be described in greater detail below, the manual search can occur either in the RRC_IDLE mode or in the RRC_CONNECTED mode.

Manual Cell Selection and Cell Search Initiation

A user application may allow the user to:

(1) Initiate a search for available HeNB cells or for a particular HeNB cell (e.g., using a cell ID, a tracking area (TA) ID, or a physical layer ID, or by using a programmed name that is mapped to one of these parameters).

(2) Select a particular cell when presented with a list of available cells.

(3) Search for all available cells or HeNB cells.

(4) Search for all available public HeNBs (e.g., hotspots) or all available private HeNBs (e.g., personal HeNBs).

(5) Initiate a search for a subset of HeNBs based on some criteria.

Parsing a Manual Command

New attention (AT) commands are proposed to allow the manual user input (e.g., from an application or menu) of the search, search criteria, or HeNB selection to be passed to the protocol stack in the WTRU. The commands may include information about the specific cell to be searched for or selected (e.g., the cell ID, the TA ID, the physical layer ID, a public HeNB, all available HeNBs, and frequency information).

New primitives are defined that allow the upper layers (e.g., an AT command handler in the non-access stratum (NAS)) to interpret the command and pass it along with associated information (e.g., the cell ID, the TA ID, or the physical layer ID) to the lower layers (e.g., to an evolved packet system (EPS) mobility management (EMM) sub-layer in the NAS or to the RRC). The decision of where to send the command is implementation-specific. In one embodiment, the command is sent to the EMM sub-layer in the NAS; this may be a preferred implementation, because the NAS controls the AT commands and is simpler to implement. Sending the command to the EMM sub-layer or to the RRC thereby provides the lower layers with an indication of whether the command was to search for HeNB cells or to select an HeNB cell.

NAS Procedures on Receipt of a Manual Command

The WTRU may receive a manual search command or a manual cell selection command when it is in any NAS EMM state. For example, the WTRU may be in the EMM_DEREGISTERED state or the EMM_REGISTERED state. In any given state, the WTRU may be in the midst of executing a particular procedure. As part of searching for HeNBs, a public land mobile network (PLMN) search may also be required. For example, a PLMN search may be required when the WTRU is powered on or if, after powering on, the WTRU cannot locate its preferred PLMN (the PLMN on which it should first attempt to camp), the WTRU will use an alternate PLMN while it searches for the preferred PLMN. To further illustrate, suppose there are two HeNBs, HeNB 1 (the preferred HeNB, on PLMN 1) and HeNB 2 (on PLMN 2). If the WTRU cannot locate HeNB 1, the WTRU would connect to HeNB 2. Because the network has indicated to the WTRU that HeNB 1 is preferred, the WTRU still needs to search for HeNB 1. Since HeNB 1 is on a different PLMN (i.e., PLMN 1), the WTRU also needs to perform a PLMN search to locate PLMN 1 before connecting to HeNB 1.

Depending on the procedure being executed by the WTRU, the NAS state or sub-state that the WTRU is in, and/or the manual inputs from the user (e.g., the PLMN identity of cell to be searched for, frequency, etc.), the WTRU may execute any of the following procedures in response to the manual cell search command or the manual cell selection command.

(1) Immediately initiate a PLMN search or selection and/or an HeNB cell search, selection, or re-selection. The WTRU passes any received manual input parameters to the lower layers to assist in the search, selection, or re-selection.

(2) Wait until the procedures being executed have completed or the procedures required in that state have been completed before initiating the search, selection, or re-selection. For example, if the WTRU is in the middle of an emergency (E911) call and is not on the preferred PLMN, the emergency call has priority over a PLMN search and the search will be delayed until the emergency call is completed.

(3) Abort any procedures currently being executed or the procedures required in the current state and immediately begin the search, selection, or re-selection. For example, if the WTRU is currently operating in a weak cell and cannot access a desired service, being able to connect to a “better” PLMN to obtain the desired service is more important than the current procedure (e.g., a data call), so the current procedure can be terminated to begin the search, selection, or re-selection.

(4) Modify the procedures being executed or the procedures required in the current state (e.g., PLMN search) with the newly received inputs from the manual cell search command. For example, certain priorities may be stored at the WTRU (e.g., on a Universal Subscriber Identity Module (USIM)) and can be modified by the network. If the priorities are modified by the network (e.g., via an over-the-air update), then the procedures may need to be modified based on the modified priorities.

(5) Execute any combination of these procedures.

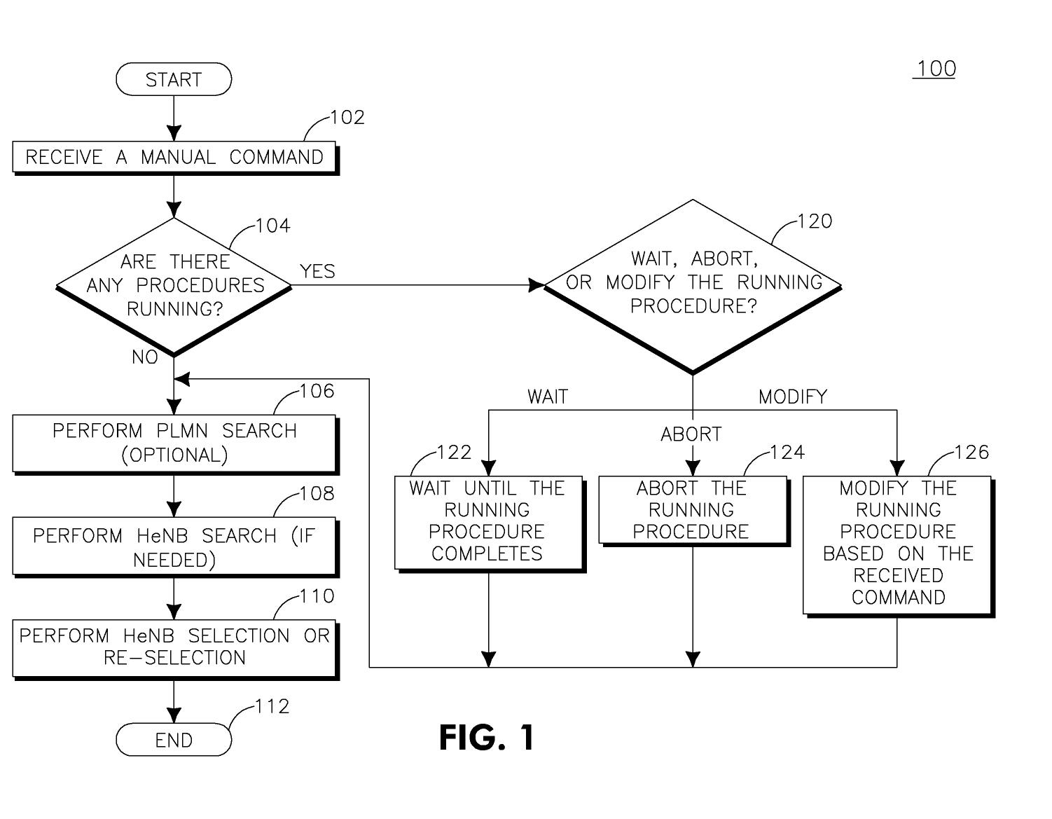

FIG. 1 is a flow chart showing NAS procedures 100 on receipt of a manual command. A manual command is received at the EMM sub-layer of the NAS (step 102). A determination is made whether any other procedures are currently running on the WTRU (step 104). If there are no procedures currently running, then a PLMN may be performed, if needed (step 106). Next, depending on the manual command, a HeNB search is performed, if needed (step 108), and then HeNB selection or re-selection is performed (step 110) and the method terminates (step 112).

If there are any procedures currently running (step 104), a determination is made whether to wait for the current procedure to complete, to abort the currently running procedure, or to modify the currently running procedure (step 120). If the WTRU is to wait, the currently running procedure is allowed to complete (step 122) and the method continues with performing a PLMN search (step 106) as described above. If the currently running procedure is to be aborted, the WTRU aborts the current procedure (step 124) and the method continues with performing a PLMN search (step 106) as described above. If the currently running procedure is to be modified, the modifications are made based on information contained in the received manual command (step 126) and the method continues with performing a PLMN search (step 106) as described above.

RRC Procedures on Receipt of a Manual Command

The WTRU may receive the manual search command or the manual cell selection command when it is in any RRC state. For example, the WTRU may be in the RRC_CONNECTED state or in the RRC_IDLE state. In executing the procedures described below, an indication may be provided to the lower layers (e.g., L1) of the search parameters (e.g., frequency layer of search, cell search, or physical layer IDs of cells).

### WTRU in the RRC IDLE State

If the WTRU is in the RRC_IDLE state, upon receipt of the manual cell search command, the WTRU may:

(1) Use idle periods when the WTRU is not monitoring paging channels for searching and measuring HeNB cells.

(2) If a cell was successfully detected, the WTRU provides an indication to the user and camps on the detected cell if it meets the cell access criteria (i.e., for re-selection) after receiving the user's command to camp on the cell.

(3) Move to the RRC_CONNECTED state on the current cell.

The manual cell selection initiation process assumes that the manual command for selection is to a particular HeNB cell that is available or detected. Upon receipt of the manual cell selection command, the WTRU may:

(1) Initiate cell selection or re-selection procedures.

(2) Camp on the selected HeNB cell.

RRC IDLE State Cell Selection and Re-Selection

In the “camped normally” state, the WTRU obtains normal service and monitors the relevant system information and the paging indicator channels. Obtaining “normal service” means that the WTRU is able to access all services that it is capable of accessing. It also performs measurements on the serving cell at least once every DRX period. If the measurements are below the cell selection criteria S, the WTRU executes the cell reselection evaluation process depending on the thresholds configured for intra-frequency, inter-frequency, and inter-RAT measurements.

Cell Selection Criteria

The cell selection criterion, S, is fulfilled when

Srxlev>0 Equation (1)

where

Srxlev=Qrxlevmeas−Qrxlevmin−Pcompensation Equation (2)

where Srxlev is the cell selection receive level value (in dB), Qrxlevmeas is the measured cell receive level value (RSRP), Qrxlevmin is the minimum required receive level in the cell (in dBm), and Pcompensation is a factor used by the WTRU to help determine on which cell it has the best chance of obtaining service.

### Measuring the Cell

When the WTRU is in the “camped normally” state, the WTRU may perform measurements on the cell indicated in the manual command according to one of the following.

(1) If the WTRU receives a manual command to trigger cell search for an HeNB (i.e., closed subscriber group (CSG)) cell that is configured in the white-list of HeNBs for the WTRU, then regardless of whether or not the serving cell meets the cell selection criterion S, it initiates measurement on the cell indicated by the manual command.

(2) If the WTRU receives a manual command to trigger cell search for an HeNB (i.e., CSG) cell that is configured in the white-list of HeNBs for the WTRU, then if the serving cell measurement does not meet a selection criterion S1, it initiates measurement on the cell indicated by the manual command. The criterion S1 may be the same as or different than the cell selection criterion S. The criterion S1 may be different for different frequencies or RATs of the manually selected cell. In one embodiment, S1 may have a different threshold value to evaluate against.

(3) If the WTRU receives a manual command to trigger cell search for “public” HeNB cells, then it initiates measurement of the cell indicated by the manual command only if the serving cell measurement (based on x number of recent measurements) does not meet a selection criterion S2. The criterion S2 may be the same as or different than S. The criterion S2 may be different for different frequencies or RATs of the manually selected cell. In one embodiment, S2 may have a different threshold value to evaluate against.

(4) If the WTRU receives a manual command to trigger cell search, then regardless of whether the serving cell meets the cell selection criterion S, and regardless of whether the cell indicated in the manual command is in the WTRU's white-list of HeNB cells or “public” HeNB cells, it initiates measurement on the cell indicated by the manual command.

Evaluating the Cell Measurements

The measurement criterion in the following procedures may use the thresholds and other parameters that may be pre-configured in the WTRU or indicated to the WTRU via dedicated or broadcast signaling.

Once a measurement of the manually selected cell is triggered and completed, the WTRU may:

(1) If the manually selected cell was an HeNB (i.e., CSG) cell, evaluate the measured value of the manually selected cell and/or the measured value of the serving cell against a measurement criterion S3. The measurement criterion S3 may be configured by the network and can be unique for all HeNBs, can be unique to one HeNB, or can be unique to a subset of HeNBs. In one embodiment, S3 may have a different threshold value to evaluate against.

The measurement criterion S3 may be the same or different than the measurement criterion S or those for intra-frequency, inter-frequency, and inter-RAT measurements. The criterion S3 may be different for different frequencies or RATs of the manually selected cell. The criterion S3 may be same or different for “public” HeNBs and “private” HeNBs. The criterion may utilize user subscription parameters. As part of checking these criteria, the WTRU may have to acquire broadcast channels of the manually selected cell. For example, if the WTRU is looking for a particular service that is only available on certain cells, the broadcast channel may indicate to the WTRU whether the service exists on the selected cell.

(2) If the manually selected cell meets the criteria configured for manual cell re-selection, the WTRU re-selects to this cell, camps on it, and re-enters the “camped normal” state.

(3) If the manually selected cell does not meet the criteria configured for manual cell re-selection, then:
(a) If the serving cell satisfied the cell selection criteria S when the measurement was triggered, then return to camping normally on the serving cell.
(b) Otherwise, proceed to intra-frequency, inter-frequency, and inter-RAT measurements to look for a suitable cell. If no suitable cell is found, the WTRU may enter the “any cell selection” state.

Suitable Cell Criteria

A “suitable cell” is a cell on which the WTRU may camp on to obtain normal service. A suitable cell fulfills all of the following requirements.

(1) The cell is part of the selected PLMN, the registered PLMN, or a PLMN on the equivalent PLMN list.

(2) According to the latest information provided by the NAS:
(a) The cell is not barred.
(b) The cell is part of at least one TA that is not part of the list of “forbidden TAs for roaming”, which belongs to a PLMN that meets criteria (1).

(3) The cell selection criteria are fulfilled.

If more than one PLMN identity is broadcast in the cell, the cell is considered to be part of all TAs with tracking area identities (TAIs) constructed from the PLMN identities and the tracking area code (TAC) broadcast in the cell.

It is noted that TA, TAI, and TAC are used as synonyms for location area (LA), location area identity (LAI), and location area code (LAC).

Classifying an HeNB Cell as a Suitable Cell

An HeNB cell may be classified as a suitable cell for normal operation based on the following criteria. An indicator (e.g., a one bit indicator on the cell broadcast, reserved PHY layer synchronization signals, or some other means) may be used to identify a cell as an HeNB cell. The indicator can also identify an HeNB cell as a private HeNB or a public HeNB.

(1) If the cell is a private HeNB (i.e., a CSG) cell or if no distinction between public and private HeNBs are made:
(a) It has an identity configured by the network in the white-list of HeNBs in the WTRU. This identity may be a TA ID, a cell ID, a PHY layer ID, a CSG ID, or some other ID.
(b) It meets the other requirements for a suitable cell with the possible exception of the cell selection criteria S, which may be different for HeNBs.

(2) If the cell is a public HeNB (i.e., a “hotspot”), it meets the other requirements for suitable cell with the possible exception of the cell selection criteria S, which may be different for HeNBs.

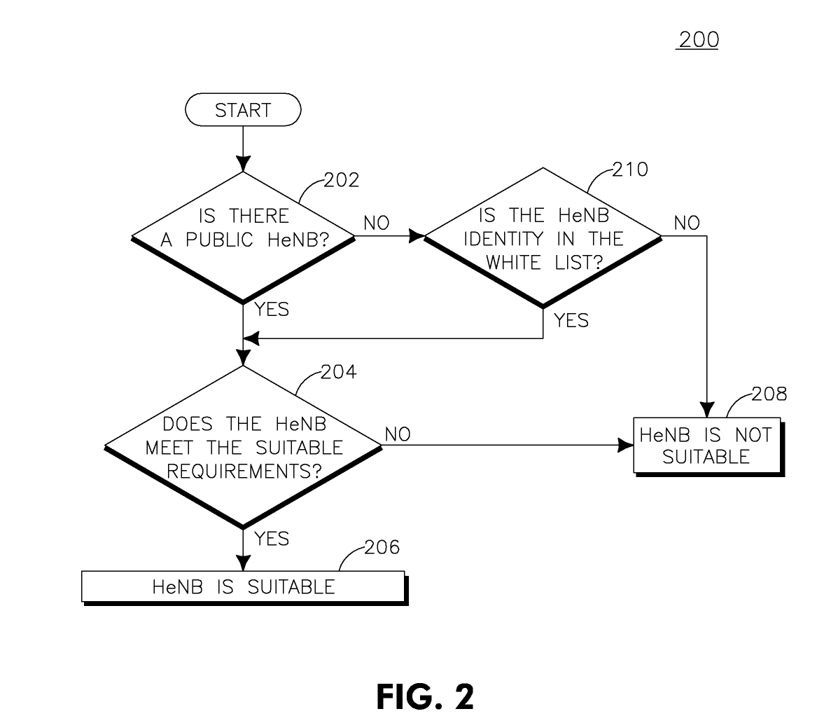

FIG. 2 is a flow chart of a method 200 for determining whether an HeNB cell is a suitable cell. First, a determination is made whether the HeNB is a public HeNB (step 202). If the HeNB is a public HeNB, then the HeNB is evaluated to determine if it meets the other requirements for a suitable cell, with the possible exception of the cell selection criteria S (step 204). If the HeNB meets the other requirements, then the HeNB is suitable (step 206). If the HeNB does not meet the other requirements, then the HeNB is not suitable (step 208).

If the HeNB is a private HeNB or if no distinction between public and private HeNBs are made (step 202), then a determination is made whether the HeNB is in the white list of the WTRU (step 210). If the HeNB is in the white list of the WTRU, then the HeNB is evaluated to determine if it meets the other requirements for a suitable cell (step 206) as described above. If the HeNB is not in the white list of the WTRU, then the HeNB is not suitable (step 208).

Acceptable Cell Criteria

An “acceptable cell” is a cell on which the WTRU may camp to obtain limited service (originate emergency calls only). An acceptable cell fulfills the following requirements, which are the minimum set of requirements to initiate an emergency call in a E-UTRAN network:

(1) The cell is not barred.

(2) The cell selection criteria are fulfilled.

Classifying an HeNB Cell as an Acceptable Cell

An HeNB cell is classified as an acceptable cell for camping for emergency services under different criteria. Three alternatives are proposed: (1) emergency services are allowed on HeNBs and the WTRU is not configured in its white-list; (2) emergency services are not allowed on HeNBs and the WTRU is not configured in its white-list; or (3) emergency services may or may not be allowed on an HeNB depending on owner preferences.

Alternative 1: If emergency services are allowed on HeNBs and the WTRU does not have access to that HeNB in its white-list, then if the cell advertises itself as an HeNB cell, that cell is categorized as an acceptable cell provided it meets the other requirements for an acceptable cell with the possible exception of the cell selection criteria S, which may be different for HeNBs. Even for an acceptable cell, there are certain requirements to be met. For example, the cell must not be barred by the network.

Alternative 2: If emergency services are not allowed on HeNBs and the WTRU does not have access to the HeNB in its white-list, then if the cell advertises itself as an HeNB cell and if the WTRU is not configured with the HeNB ID (e.g. TA ID, cell ID, PHY layer ID, CSG ID or some other ID) in its white-list, then that cell will not be categorized as an acceptable cell.

Alternative 3: If emergency services are allowed on a selective basis (i.e., some users allow emergency services on their private HeNBs and others do not) then the HeNB has the ability to advertise whether it supports emergency services or may be used as an acceptable cell or not. This advertisement may take the form of an indication (e.g., one bit) on the broadcast channel or by some other means. If the cell advertises itself as an HeNB cell and if the WTRU is not configured with the HeNB ID (e.g., a TA ID, a cell ID, a PHY layer ID, a CSG ID, or some other ID) in its white-list and if the HeNB advertises itself as an acceptable cell for emergency access, then that cell will be categorized as an acceptable cell provided it meets the other requirements for an acceptable cell with the possible exception of the cell selection criteria S, which may be different for HeNBs. Otherwise, if the HeNB advertises itself as an acceptable cell for emergency services and the WTRU is not configured with the HeNB ID (e.g., a TA ID, a cell ID, a PHY layer ID, a CSG ID, or some other ID) in its white-list, then this cell will not be categorized as an acceptable cell.

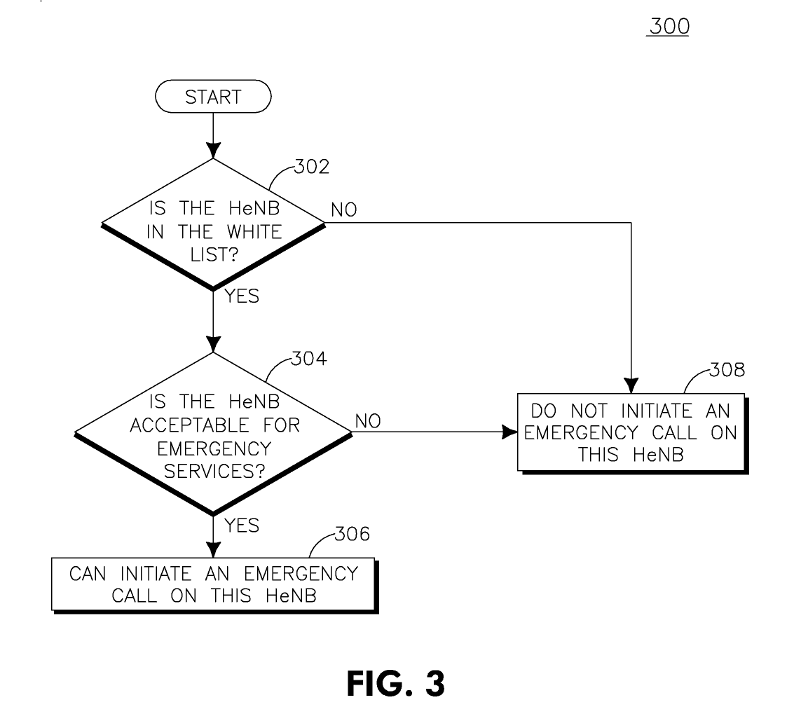

FIG. 3 is a flow chart of a method 300 for determining whether an HeNB cell is an acceptable cell for making emergency calls. First a determination is made whether the HeNB is in the WTRU's white list (step 302). If the HeNB is in the white list, then the HeNB is evaluated to determine whether it is acceptable for emergency services (step 304). If the HeNB is acceptable for emergency services, then an emergency call can be initiated on the HeNB (step 306). If the HeNB is not acceptable for emergency services, then an emergency call will not be initiated on the HeNB (step 308). If the HeNB is not in the WTRU's white list (step 302), then an emergency call will not be initiated on the HeNB (step 308).

WTRU is in the RRC CONNECTED State

Cell Search

If the WTRU is in the RRC_CONNECTED state, the WTRU may perform any combination of the following procedures upon receipt of the manual cell search command.

(1) Use the measurement gaps configured by the network to search for HeNB cells. The WTRU may use measurement gaps specially configured for measurement of HeNB cells or measurement gaps configured for other measurements. If the measurement gap is not specifically configured for measuring HeNB cells, the WTRU first evaluates if there are other inter-frequency or inter-RAT measurements other than HeNB measurements to be performed and then determines if there are enough measurement gaps left for HeNB measurement. If there are enough measurement gaps, then use the current measurement gap for the HeNB measurement. Otherwise, request a measurement gap to be allocated for searching for HeNB cells. Alternatively, the WTRU may prioritize measurement of the manually selected HeNB cells over the configured measurements.

(2) A new time-to-trigger (TTT) for HeNB measurements is proposed. The TTT is a timer used by the WTRU to trigger sending a measurement report to the HeNB (when the strength of a neighbor cell is greater than the strength of the serving cell for the length of the timer), the report being used to trigger a handover. The TTT may be pre-configured in the WTRU or may be signaled to the WTRU using dedicated or broadcast signaling. Upon receiving a manual command to search for HeNBs, the WTRU may scale the TTT. The scaling factor may be determined by the WTRU using some algorithm or may be signaled to the WTRU using dedicated and/or broadcast signaling. One example of an algorithm that can be used is to count the number of handovers or count the signal strength of the serving cell, since it may not be desirable to change cells too quickly, such as in a high-speed mobility scenario. It is noted that the operation of this procedure is not dependent on the algorithm used to scale the TTT, and any algorithm known to the WTRU can be used.

(3) If the HeNB is on a different frequency or RAT, then the WTRU may, upon receiving a manual command to search for HeNBs, scale the TTT for inter-frequency or inter-RAT measurements. The scaling factor may be determined by the WTRU using some algorithm or may be signaled to the WTRU using dedicated or broadcast signaling.

(4) Use any discontinuous reception (DRX) periods configured by the network to search for HeNB cells.

(5) Move to the RRC_IDLE state.

(6) Request a measurement gap to be allocated for searching for HeNB cells. This may be done using any combination of the following steps.
(a) Indicate the measurement gap request in a separate RRC message, in an existing RRC message, or in any other uplink signaling. The indication may include parameters for the search (HeNB identity, frequency, PLMN, etc.) which allow the network to verify the parameters of the manual search before configuring a gap for it. A new information element (IE) (e.g., one bit) may be included in any uplink message (e.g., any RRC message or physical (PHY) layer indication) to indicate to the network that a manual cell search or selection request was received. This option allows the WTRU to request a measurement gap, provide a reason for the measurement gap request, and specify some parameters (e.g., HeNB identity), which allows the network to know the reason for the request and to verify the parameters of the manual search.
(b) Implicitly request a measurement gap. For example, by deliberately reducing the reported measurement of the current cell or the CQI parameter, this could indicate that a measurement gap is needed.
(c) A new measurement event that indicates to the network that the measurement trigger was a manual search or selection command. This measurement event may be included in the measurement report provided to the network. This option allows the WTRU to request a measurement gap and to provide a reason for the measurement gap request.
(d) The WTRU may request a measurement gap and without providing a reason for the measurement gap request and without providing any parameters along with the request.
(e) The request may include an indication to the network of the scale of the search to be performed (e.g., a particular HeNB or all available public HeNBs) to allow the network to configure a measurement gap of appropriate length.
(f) The network may choose not to configure a measurement gap for a manual search.
(g) The network may command the WTRU to search for the cell when it next moves to the RRC_IDLE state. An indication of the command may be provided to the WTRU implicitly or explicitly (via signaling).

Upon completing the search procedure, the WTRU may:

(1) Provide the user with the search results (e.g., the detected HeNBs).

(2) Provide the user only with the HeNBs to which access is possible (e.g., based on subscription information, PLMN, services offered, etc.) or the HeNBs to which access is not allowed (if the number of these HeNBs is small, this may be more efficient).

(3) Provide the user with an indication of the quality measure of the detected HeNBs.

(4) Initiate cell selection or re-selection in the RRC_IDLE state.

(5) Initiate handover in the RRC_CONNECTED state.

(6) Provide a measurement report to the network. If the measurement report to the network indicates that the measurement event was a manual request, the network may respond with a handover command after (optionally) preparing resources at the target cell.

Cell Selection

The manual cell selection initiation process assumes that the manual command for selection is to a particular HeNB cell that is available or detected. The WTRU may perform any combination of the following procedures upon receipt of the manual cell selection command.

(1) Perform a manual search procedure. The search may not have been previously performed, depending on the actions taken by the WTRU prior to needing the search to be performed. For example, suppose that a WTRU is camped on HeNB 2, but its preferred HeNB is HeNB 1. If the WTRU is in the middle of a call on HeNB 2, but needs to access a service via HeNB 1, then a manual search will have to be performed to locate HeNB 1.

(2) Request a handover to a particular HeNB cell. This may be done using any combination of the following steps:
(a) Indicate the handover request in a separate RRC message or in an existing RRC message.
(b) Implicitly request the handover. For example, the measurements taken of a neighboring cell are continuously getting stronger over a period of time, while the serving cell is still acceptable. The fact that the neighboring cell is getting stronger is communicated to the network through periodic measurement reports. Based on these reports, the network may determine that the WTRU should be handed over to the neighboring cell.
(c) The network prepares resources at the selected HeNB cell and sends a handover command to the WTRU.
(d) The network configures a measurement gap and requests the WTRU to make measurements. For example, additional measurements may be needed to make an accurate determination before requesting a handover.
(e) The network sends a handover command to the WTRU.

(3) Move to the RRC_IDLE state and re-select to the selected HeNB cell.

(4) Begin initial access procedures on the selected HeNB cell.

Upon completion of the selection procedure, the WTRU may provide the user with the results of the selection (e.g., whether the selection was successful or unsuccessful).

Apparatus

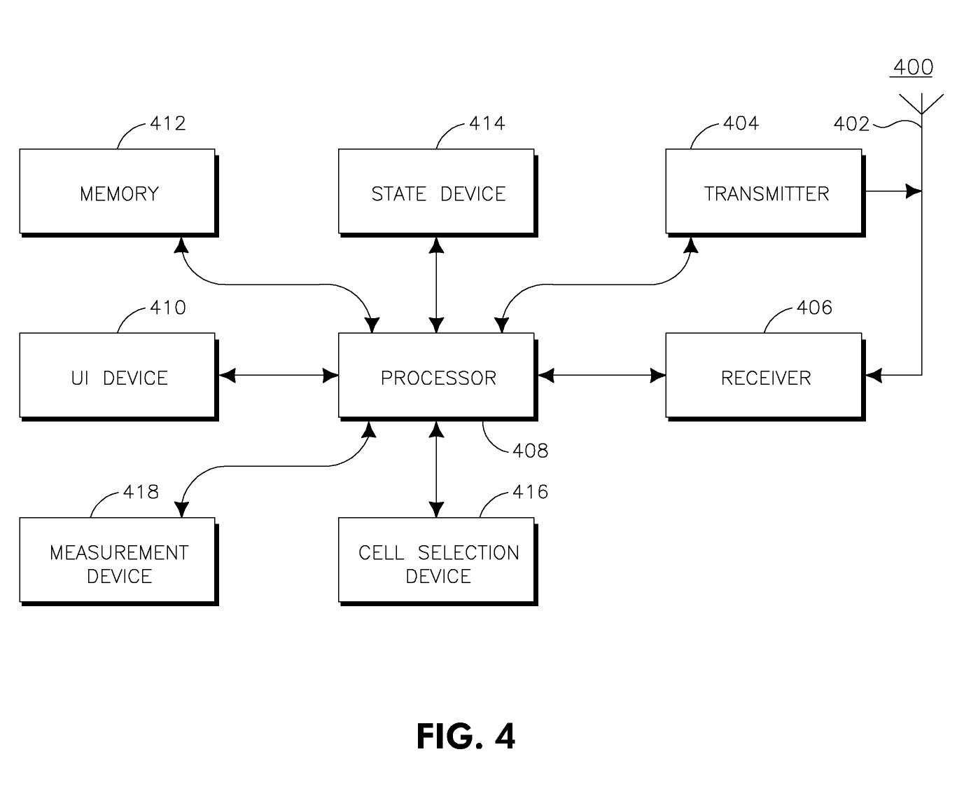

FIG. 4 is a block diagram of a WTRU 400 configured to perform manual cell detection and selection. The WTRU includes an antenna 402, a transmitter 404 in communication with the antenna 402, and a receiver 406 in communication with the antenna 402. A processor 408 is in communication with both the transmitter 404 and the receiver 406. The WTRU further includes a user interface (UI) device 410, a memory 412, a state device 414, a cell selection device 416, and a measurement device 418, all of which are in communication with the processor 408 which coordinates the other devices 410-418.

The UI device 410 is configured to permit a user of the WTRU 400 to enter manual commands, including, but not limited to, search parameters and cell selections. The memory 412 is configured to store information relating to the operation of the WTRU 400, including, but not limited to, a white-list of acceptable HeNBs. The state device 414 is configured to monitor and change the state of the WTRU 400, for example, from an idle state to a connected state and back. The cell selection device 416 is configured to assist the WTRU 400 in selecting or re-selecting to a new cell, based on a manual command. The measurement device 418 is configured to take measurements of the radio environment as needed to support the other functions of the WTRU 400. It is noted that the functionality of the devices 410-418 could be incorporated into the processor 408 without affecting the operation of the WTRU 400.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method for performing a manual cell search by a wireless transmit/receive unit (WTRU), comprising:
receiving a manual cell search command; and
searching for home enhanced Node B (HeNB) cells during a time period.

2. The method according to claim 1, wherein the time period is a measurement gap.

3. The method according to claim 2, wherein the searching includes using an existing measurement gap.

4. The method according to claim 3, wherein if the existing measurement gap is not configured for measuring HeNB cells, then determining if inter-frequency or inter-radio access technology measurements are scheduled to be made;
determining if there are enough measurement gaps available to support HeNB measurements;
using a current measurement gap if there are enough measurement gaps available; and
requesting a measurement gap if none are available.

5. The method according to claim 4, wherein the requesting includes sending a separate measurement gap request, the request including parameters for the cell search.

6. The method according to claim 4, wherein the requesting includes implicitly requesting a measurement gap by reducing a reported measurement of the current cell.

7. The method according to claim 4, wherein the requesting includes including a measurement event in a measurement report sent to a network.

8. The method according to claim 1, wherein the time period is a discontinuous reception period.

9. The method according to claim 1, further comprising receiving a command to perform the cell search when the WTRU enters an idle state.

10. A method for processing a manual cell search command, comprising:
setting a time-to-trigger (TTT) timer, the timer used by a wireless transmit/receive unit (WTRU) to trigger sending a measurement report to a home enhanced Node B;
receiving a manual cell search command; and
scaling the TTT timer by a scaling factor upon receipt of the manual cell search command.

11. The method according to claim 10, wherein the scaling factor is determined by the WTRU.

12. The method according to claim 10, wherein the scaling factor is received by the WTRU via signaling.

13. The method according to claim 10, wherein the scaling includes scaling the TTT for inter-frequency or inter-radio access technology measurements.

14. A handset, comprising:
an antenna;
a receiver in communication with the antenna;
a transmitter in communication with the antenna; and
a processor, configured to:
receive a manual command from a user of the handset, the manual command including at least one of: a home enhanced Node B (HeNB) cell search, an HeNB cell selection, or an HeNB cell re-selection; and
perform the manual command.
